(19) United States
(12) Patent Application Publication
(10) Pub. No.: US 2025/0298172 A1
(43) Pub. Date: Sep. 25, 2025

(54) MEDICAL DEVICE COMPRISING AN OPTICAL ELEMENT WITH ANTI-REFLECTIVE COATING

(71) Applicant: Bühler Alzenau GmbH, Alzenau (DE)

(72) Inventors: Rainer GÖTZELMANN, Alzenau (DE); Harro HAGEDORN, Alzenau (DE)

(21) Appl. No.: 19/105,068

(22) PCT Filed: Aug. 18, 2023
(86) PCT No.: PCT/EP2023/072794

§ 371 Date: Feb. 20, 2025

(30) Foreign Application Priority Data
Aug. 22, 2022 (EP) 22191485.6

(51) Int. Cl. G02B 1/11

(52) U.S. Cl. CPC G02B 1/11

(57) ABSTRACT

A medical device including an optical element having a substrate and an anti-reflective coating applied to an application surface of the substrate, the anti-reflective coating including an alternating layer sequence of sublayers having different refractive indices. In addition to the alternating layer sequence, the anti-reflective coating including an anti-corrosion layer, which is the layer of the anti-reflective coating that is farthest away from the application surface of the substrate. The anti-corrosion layer is designed such that the ratio of the refractive index of the anti-corrosion layer to the layer thickness of the anti-corrosion layer in nanometers is in the range of from 0.3 to 0.9. Furthermore, the use of an optical element in a medical device is indicated.

### FIELD OF THE INVENTION

The invention relates to a medical device comprising an optical element having a substrate and an anti-reflective coating applied to an application surface of the substrate, and to the use of an optical element.

### BACKGROUND

Anti-reflective coatings are used to increase the transmission of light that is incident on an optically transparent substrate and/or to at least reduce the extent of interfering optical influences. The problem arising here is that the anti-reflective coating, as the outermost component of the respective optical element, comprising the substrate and the anti-reflective coating, is exposed to environmental influences that may impair the functionality of the anti-reflective coatings. This effect is even intensified in anti-reflective coatings in that the outermost sublayer of the anti-reflective coating, that is, the layer on which the incident electromagnetic radiation impinges, should consist of a material having as low a refractive index as possible in order to be able to achieve as high a transmittance as possible. However, such materials are particularly susceptible to damage.

It is known to protect anti-reflective coatings against mechanical stresses and damage resulting therefrom, such as, for example, scratches. For this purpose, materials having a high refractive index are applied as the outermost sublayer of the anti-reflective coating, since such materials usually exhibit an increased resistance to mechanical stresses.

For example, DE 10 2018 116 993 B4 describes an optical component having a layer stack that includes successive layers of at least three types, each having different refractive indices. The topmost layer has a lower refractive index than the second topmost layer, but a higher refractive index than a further layer that is arranged below the topmost and second topmost layers.

US 2018/0081085 A1 describes electronic devices such as mobile phones, computers and watches that comprise a transparent element that is, for example, a display or a camera window. The transparent element is provided with an anti-reflective coating that includes an alternating sequence of high and low refractive index dielectric layers. In order to increase the scratch resistance of the anti-reflective coating, an outermost interference filter layer may be applied to the anti-reflective coating, which consists of a highly refractive material.

WO 2022/125846 A1 discloses a cover glass for electronic devices, such as mobile devices, tablets and vehicle displays, having an outer optical film structure and an inner optical film structure, which each comprise a plurality of alternating high and low refractive index sublayers. The high refractive index sublayers of the outer optical film structure comprise a nitride or oxynitride and the high refractive index sublayers of the inner optical film structure comprise an oxide or nitride. A scratch-resistant layer made from a highly refractive material may further be applied to the outer optical film structure.

Depending on the application, however, it is not sufficient to ensure the resistance to mechanical stress. Rather, it may be necessary to be able to additionally provide a resistance to chemicals. In particular in the case of optical elements for use in medical devices, regular cleaning with chemically aggressive treatment solutions, for example strongly alkaline solutions, is necessary. This effect is further intensified by the fact that commonly used cleaning processes have to be carried out in autoclaves, which additionally generates a high pressure and temperature load.

### SUMMARY

It is therefore the object of the invention to provide an optical element having an anti-reflective coating for use in medical devices, which is resistant to chemicals such as alkaline solutions and at the same time exhibits a high transmittance and/or a low reflectance, as well as a medical device including such an optical element.

The object is achieved by a medical device according to claim 1 and the use of an optical element according to claim 14. Advantageous embodiments are indicated in the dependent claims, which may be combined with each other as desired.

The medical device according to the invention includes an optical element having a substrate and an anti-reflective coating applied to an application surface of the substrate, wherein the anti-reflective coating includes an alternating layer sequence of sublayers having different refractive indices. In addition to the alternating layer sequence, the anti-reflective coating includes an anti-corrosion layer, which is the layer of the anti-reflective coating that is farthest away from the application surface of the substrate. The anti-corrosion layer is designed such that the ratio of the refractive index of the anti-corrosion layer to the layer thickness of the anti-corrosion layer in nanometers is in the range of from 0.3 to 0.9.

The invention is based on the fundamental idea of additionally providing an anti-corrosion layer on the alternating sequence of layers necessary for the desired optical transmittance, with the refractive index and the layer thickness of the anti-corrosion layer being specifically adapted to each other. In this way, it is possible to also use highly refractive materials in the anti-corrosion layer which have a high resistance to chemicals, without the transmission through the anti-reflective coating being overly impaired. At the same time, however, the anti-corrosion layer has a certain thickness so that it is not completely degraded even after multiple cleaning processes, thus increasing the lifetime of the anti-reflective coating and the optical element.

In this sense, the anti-corrosion layer acts as a “capping” layer of the anti-reflective coating.

When calculating the ratio between the refractive index and the layer thickness of the anti-corrosion layer, the layer thickness in nanometers is used according to the invention. It should be appreciated, however, that for the calculation of the ratio, the respective value of the layer thickness is used without dimension, so that the ratio in the range of from 0.3 to 0.9 is also dimensionless. For example, an anti-corrosion layer having a refractive index nₖ of 2.0 and a layer thickness dₖ of 3.2 nm has a ratio α=nₖ/dₖ=2.0/3.2 of 0.625.

The refractive index is the refractive index as measured at a measuring temperature of 20° C. and a wavelength of 550 nm.

The anti-corrosion layer consists in particular of a highly refractive material selected from the group consisting of zirconium oxide, hafnium oxide and mixed oxides thereof.

Preferably, the highly refractive material is zirconium oxide or hafnium oxide, particularly preferably zirconium oxide.

What is decisive for the suitability as a highly refractive material of the anti-corrosion layer is in particular the resistance to chemicals, especially alkaline solutions. It has been found that in particular zirconium oxide, hafnium oxide and mixed oxides thereof are suitable in this respect and thus make a particularly resistant anti-corrosion layer possible. By matching the refractive index and the layer thickness of the anti-corrosion layer according to the invention, good optical properties of the anti-reflective coating may furthermore be achieved in addition.

It has further been found that some materials that are commonly employed for protecting anti-reflective coatings from mechanical damage, for example to protect them from scratches, do not exhibit sufficient resistance to chemicals. In this sense, aluminum oxide (Al₂O₃), silicon nitride (Si₃N₄), niobium oxide (Nb₂O₅) and titanium oxide (TiO₂) in particular are not suitable as materials for the anti- corrosion layer of the optical element according to the invention.

The use of so-called “diamond-like carbon” (abbreviated as “DLC”), which is known in particular for use in anti-scratch layers due to its hardness, is also not intended according to the invention as a material of the anti-corrosion layer.

The anti-corrosion layer may have a refractive index in the range of from 1.8 to 2.5, preferably in the range of from 1.9 to 2.2. If the refractive index of the anti-corrosion layer is above 2.5, the transmittance of the anti-reflective coating may be reduced excessively or the anti-corrosion layer would have to be designed to be so thin that sufficient chemical resistance or corrosion resistance cannot be ensured.

Furthermore, the anti-corrosion layer may have a layer thickness in the range of from 3.0 to 6.0 nm, preferably in the range of from 3.0 to 5.0 nm. If the layer thickness is below 3.0 nm, the resistance and lifespan of the anti-corrosion layer is overly limited or shortened. With a layer thickness of more than 6.0 nm, the transmittance of the anti-reflective coating may be reduced too much.

In order to further increase the resistance of the anti-corrosion layer, the anti-corrosion layer may be applied by means of sputtering, in particular by means of DC sputtering, RF sputtering, magnetron sputtering or ion beam sputtering. It has been found that sputtering methods produce a particularly resistant or resilient anti-corrosion layer, in particular in comparison to application methods in which the respective material is merely vapor-deposited, for example ion-assisted vapor deposition or plasma-assisted vapor deposition.

This effect is attributed to the fact that the particles or ions generated during sputtering have a higher kinetic energy at the time of impact on the object to be coated, in the present case the alternating layer sequence, than is the case with other application processes. In this way, a higher packing density is generated in the anti-corrosion layer applied, which in turn increases the resistance, in particular the resistance to chemicals.

In particular, the anti-corrosion layer has a packing density of 90% or more of the theoretically maximum achievable packing density.

Moreover, the surface roughness of the anti-corrosion layer can be reduced by applying the anti-corrosion layer by means of sputtering. Accordingly, the anti-corrosion layer in particular has a surface roughness Rₐ of 0.50 nm or less. This allows the lifetime of the anti-corrosion layer to be increased even further. The surface roughness Rₐ may be measured in accordance with DIN EN ISO 4287:2010.

In one variant, the optical element exhibits an increase in reflectance of 1% or less after six stripping cycles, wherein one stripping cycle includes treatment of the optical element in an ultrasonic bath having a power of 300 W at a temperature of 60° C. for one hour, and the ultrasonic bath including an aqueous potassium hydroxide solution having a concentration of 10 percent by weight of potassium hydroxide, based on the total weight of the potassium hydroxide solution.

The stripping cycle, in which the optical element is immersed and treated within the alkaline ultrasonic bath, provides a simple and quick test method that allows the durability of the anti-reflective coating, in particular the resistance of the anti-corrosion layer, to be checked. In particular, the stress on the anti-reflective coating caused in this way is comparable to the conditions to which the optical element is exposed in known cleaning processes for application in the medical or clinical field. Thus, the stress within one stripping cycle as described above roughly corresponds to the stress to which the optical element would be subjected in several cleaning cycles in an autoclave in the medical or clinical field.

The increase in reflectance is determined as the mean value of the increase in reflectance over a wavelength range of from 400 nm to 750 nm. The reflectance can be measured using a spectrophotometer.

The alternating layer sequence may comprise one or more coats, with each coat having a first sublayer and a second sublayer and the refractive index of the first sublayer being lower than the refractive index of the second sublayer. The sequence of coats that results from this combination of sublayers having different refractive indices allows the interference behavior of the anti-reflective coating to be precisely controlled.

It will be appreciated that the sublayers of directly adjacent coats are selected and arranged such that the alternating layer sequence is given. This means that, for example, in the case where a coat includes a first sublayer as the uppermost sublayer, the next more remote coat as viewed from the substrate includes a second sublayer as the lowermost sublayer.

In one variant, the anti-corrosion layer is applied directly to a first sublayer of the alternating layer sequence. In other words, a first sublayer, which has a lower refractive index than the second sublayer, is followed by the anti-corrosion layer provided according to the invention. In particular, the anti-corrosion layer has a higher refractive index than the first sublayer, so that in this variant it is ensured that a sequence of layers having a lower refractive index and layers having a higher refractive index is realized. In this way, the desired anti-reflection behavior of the anti-reflective coating can be ensured and thus a high transmittance and a low reflectance can be achieved.

Preferably, the optical element has a reflectance of 0.5% or less, the reflectance being the mean value of the reflectance over a wavelength range of from 400 nm to 750 nm.

In order to obtain a particularly high transmittance or a particularly low reflectance, the alternating layer sequence may comprise at least four coats.

Preferably, the medical device is an endoscope.

The term “optical element” includes both elements that are merely at least partially optically transparent, such as windows, for example, and elements that have an optical effect, such as, for example, a lens or a prism.

In applications for medical devices, the resistance to chemicals is of particular importance, since such devices need to be cleaned and/or disinfected very frequently, usually after each use; in particular, aggressive chemicals such as alkaline solutions are employed here. Therefore, the resistance to chemicals or chemical stability of components of optical elements that are exposed to these chemicals is of particular importance for suitability for use in a medical device.

Particularly preferably, the optical element is a lens or a window of the medical device, in particular a lens or a window of an endoscope.

The object of the invention is further achieved by the use of an optical element having a substrate and an anti-reflective coating applied to an application surface of the substrate in a medical device, wherein the anti-reflective coating includes an alternating layer sequence of sublayers having different refractive indices. In addition to the alternating layer sequence, the anti-reflective coating includes an anti-corrosion layer, which is the layer of the anti-reflective coating that is farthest away from the application surface of the substrate. The anti-corrosion layer is designed such that the ratio of the refractive index of the anti-corrosion layer to the layer thickness of the anti-corrosion layer in nanometers is in the range of from 0.3 to 0.9.

The optical element is used in particular in a medical device as described above. The features and characteristics of the medical device according to the invention apply analogously to the use of the optical element, and vice versa.

### BRIEF DESCRIPTION OF THE DRAWINGS

Further characteristics and features will be apparent from the description below of exemplary embodiments and test results, which are not meant to be understood in a limiting sense, as well as from the drawings, in which:

FIG. 1 shows a schematic representation of an optical element according to the invention for use in a medical device according to the invention;

FIG. 2 shows a diagram illustrating the behavior of the reflectance of an optical element according to a comparative example over several stripping cycles; and

FIG. 3 shows a diagram illustrating the behavior of the reflectance of an optical element according to the invention over several stripping cycles.

### DETAILED DESCRIPTION

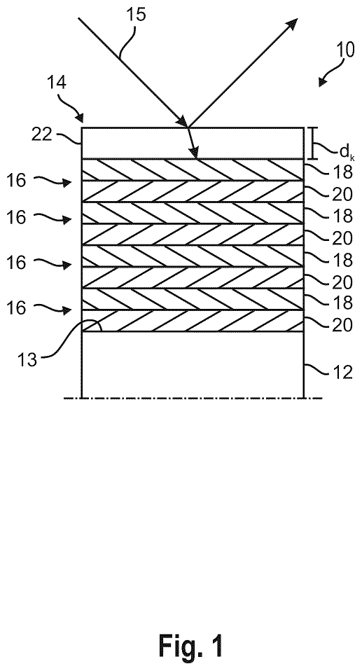

FIG. 1 schematically illustrates an optical element 10 according to the invention for use in a medical device not shown in greater detail.

For example, the medical device involved is an endoscope in which the optical element 10 is employed as a lens or window of the endoscope.

The optical element 10 comprises a substrate 12 and an anti-reflective coating 14 applied to an application surface 13 of the substrate 12.

The substrate 12 is made of an optically transparent material, that is, a material that is at least partially transparent to electromagnetic radiation 15, in particular to electromagnetic radiation having a wavelength in the range of from 400 nm to 750 nm.

For example, the optically transparent material of the substrate 12 is sapphire, glass or quartz.

It will be appreciated that, depending on the contemplated application of the optical element 10, the wavelength range of the electromagnetic radiation may also be designed differently.

The anti-reflective coating 14 has an alternating layer sequence of layers or coats 16, which each have a first sublayer 18 and a second sublayer 20.

The refractive index of the first sublayers 18 is in each case lower than the refractive index of the second sublayers 20 of the respective coat 16.

For example, the refractive index of the first sublayers 18 is in the range of from 1.4 to 1.6 and the refractive index of the second sublayers 20 is in the range of from 1.9 to 2.4. Therefore, the first sublayers 18 may also be referred to as “low refractive sublayers” and the second sublayers 20 may also be referred to as “high refractive sublayers”.

For example, the first sublayer 18 consists of silicon oxide (SiO₂, refractive index in the range from 1.46 to 1.48) and the second sublayer 20 consists of Ta₂O₅ (refractive index in the range from 2.10 to 2.20).

In the embodiment shown, the anti-reflective coating 14 has a total of four coats 16. The anti-reflective coating 14 may, of course, also have fewer or more coats 16, as long as the respectively required transmittance or reflectance can be achieved with the appropriate number of coats 16.

Similarly, in the schematic representation in FIG. 1, all sublayers 18 and 20 and thus all coats 16 have the same thickness. However, the thicknesses of the sublayers 18 and 20 and of the coats 16 may also differ from one another.

According to the invention, an anti-corrosion layer 22 is additionally applied to the layer sequence of coats 16, namely directly to the first sublayer 18 of the uppermost of the coats 16 of the alternating layer sequence, i.e. to that sublayer 18 which is located farthest away from the substrate 12.

The anti-corrosion layer 22 serves to protect the alternating layer sequence from damage, in particular from damage due to exposure to aggressive chemicals such as alkaline solutions.

In the embodiment shown, the anti-corrosion layer 22 is made of a high refractive material selected from the group consisting of zirconium oxide (ZrO₂), hafnium oxide (HfO2) and combinations thereof.

Particularly preferably, the high refractive material of the anti-corrosion layer 22 is zirconium oxide (ZrO₂).

Such materials exhibit a high chemical resistance to aggressive chemicals and at the same time provide protection against mechanical damage.

The anti-corrosion layer 22 has a layer thickness dₖ in the range of from 3.0 to 6.0 nm.

The high refractive index of the highly refractive material of the anti-corrosion layer 22 may, however, lead to an undesirable decrease in the transmittance or an undesirable increase in the reflectance of the optical element 10. In order to compensate for this effect and at the same time maintain the resistance of the anti-corrosion layer 22 and thus of the anti-reflective coating 14, it is provided according to the invention that the ratio a from the refractive index nₖ of the anti-corrosion layer 22 and the layer thickness dₖ of the anti-corrosion layer 22 in nanometers is in the range of from 0.3 to 0.9.

It has been surprisingly found that in this way wear-resistant materials can be used in the anti-corrosion layer 22 which as such have a comparatively high refractive index, while still the transmittance or reflectance is at most insignificantly impaired.

This effect is intensified in that the anti-corrosion layer 22 is applied to the uppermost of the first sublayers 18 by means of sputtering, as a result of which a high packing density of the anti-corrosion layer 22 and a low surface roughness are achieved.

### Tests Regarding Chemical Resistance

The effect of the anti-corrosion layer 22 provided according to the invention will be further illustrated below with reference to test results.

### Example 1 (Comparative Example)

An anti-reflective coating, which was built up from a layer sequence of four coats, was applied to a sapphire substrate, onto an application surface of the sapphire substrate, wherein each coat was composed of a low refractive sublayer and a high refractive sublayer. The outermost of the sublayers of the anti-reflective coating, that is, the sublayer that was farthest away from the sapphire substrate, was a low refractive sublayer.

The respective sublayers were applied by sputtering.

Starting from the sapphire substrate, the layer structure of the anti-reflective coating was as follows: Nb₂O₅ (d=14 nm), SiO₂ (d=37 nm), Nb₂O₅ (d=25 nm), SiO₂ (d=50 nm), Nb₂O₅ (d=11 nm), SiO₂ (d=335 nm), Nb₂O₅ (d=10.4 nm), SiO₂ (d=31.6 nm), Nb₂O₅ (d=140 nm), SiO₂ (d=79 nm).

### Example 2 (Example According to the Invention)

Analogously to the comparative example, a sapphire substrate was provided, on an application surface of the sapphire substrate, with an anti-reflective coating as previously described for Example 1, wherein the outermost sublayer consisting of SiO₂ had a thickness of only 70 nm instead of 79 nm.

In addition, an anti-corrosion layer was applied to the uppermost of the coats of the anti-reflective coating, namely to the uppermost sublayer of the uppermost coat, which was a low refractive sublayer, by means of sputtering, wherein the anti-corrosion layer consisted of ZrO₂.

The anti-corrosion layer had a thickness of 5.0 nm and a refractive index of 2.05.

### Resistance Test

The behavior of the optical elements manufactured in accordance with Examples 1 and 2 under conditions as are to be expected during cleaning cycles in medical applications was simulated as follows by means of stripping cycles.

Initially, the reflectance R in a wavelength range from 350 to 800 nm of the optical element as manufactured was determined using a spectrophotometer.

An ultrasonic bath was provided, which included an ultrasonic tank having a capacity of 10 L. The ultrasonic tank was approximately half filled with a potassium hydroxide solution that had a concentration of 10 percent by weight of potassium hydroxide (KOH), and the potassium hydroxide solution was heated to a temperature of 60° C.

Subsequently, the respective optical element to be tested was treated with several stripping cycles and the reflectance R of the optical element was determined again in a wavelength range from 350 to 800 nm after each stripping cycle using a spectrophotometer.

A stripping cycle comprised the following steps:
(a) placing the optical element to be tested in a holder of the ultrasonic tank so that the optical element is fully covered by potassium hydroxide solution;
(b) sonicating the optical element with an RF power of 300 W at 60° C. for one hour;
(c) removing the optical element from the ultrasonic tank, rinsing with fresh water and manually cleaning the surface.

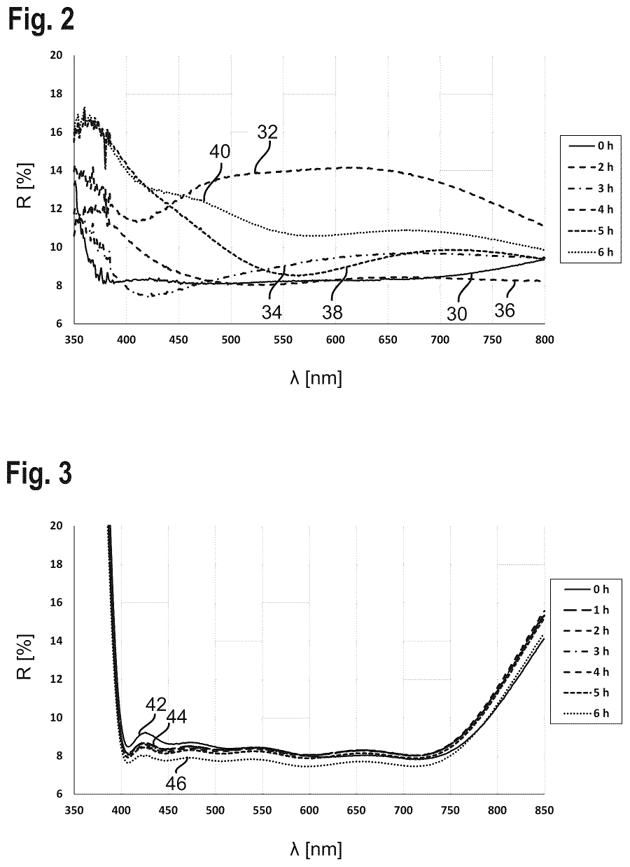

FIG. 2 shows the measured reflectances R for Example 1, which is not according to the invention.

At the beginning, the optical element had a reflectance of about 8% in the range of from 400 to 750 nm (curve 30). The fact that the reflectance was comparatively high already at the outset is due to the fact that the substrate used was a sapphire substrate that is antireflection-coated on only one side.

It can be seen that the reflectance initially increases after two stripping cycles (curve 32) before it decreases after three and four stripping cycles (curves 34 and 36, respectively) and then increases again after five and six stripping cycles (curves 38 and 40, respectively).

In FIG. 2, the curves are also provided with a designation of “x h”, where “x” indicates the number of hours that the optical element has spent in the ultrasonic bath during the stripping cycles that have already been performed. Accordingly, “0 h” denotes the measurement results of the optical element before the first stripping cycle, “2 h” denotes the measurement results of the optical element after two stripping cycles, etc.

This behavior is attributable to the fact that the sublayers of the coats of the optical element, which have different refractive indices, are removed. As a result, the reflectance increases as soon as an uppermost sublayer, which has a low refractive index, is removed and a sublayer arranged below it, which has a higher refractive index than the low refractive sublayer, is exposed. As soon as this sublayer is removed for its part, exposing a further sublayer which in turn is a low refractive sublayer, the reflectance decreases again and so on.

It is, however, also apparent from FIG. 2 that the mean reflectance is higher due to the degradation of the sublayers of the optical element in comparison to the original state and the optical properties of the optical element therefore deteriorate.

FIG. 3, on the other hand, shows the behavior of the optical element according to the invention as per Example 2.

In this case, it can be seen that in comparison to the initial state (curve 42), the mean reflectance has decreased after one to six stripping cycles (curves 44 and 46, respectively). This effect is due to the fact that any impurities on the surface of the anti-corrosion layer are removed in the first stripping cycles and the anti-corrosion layer may possibly be decomposed to a minor extent.

However, it is apparent from the measurement results that the behavior observed in comparative example 1 does not occur, but that even after several stripping cycles, the optical properties of the optical element are retained.

1. A medical device comprising an optical element having a substrate and an anti-reflective coating applied to an application surface of the substrate,
wherein the anti-reflective coating comprises an alternating layer sequence of sublayers having different refractive indices,
wherein, in addition to the alternating layer sequence, the anti-reflective coating comprises an anti-corrosion layer, which is the layer of the anti-reflective coating that is farthest away from the application surface of the substrate,
wherein the anti-corrosion layer is designed such that a ratio of a refractive index of the anti-corrosion layer to a layer thickness of the anti-corrosion layer in nanometers is in a range of 0.3 to 0.9.

2. The medical device according to claim 1, wherein the anti-corrosion layer (consists of a highly refractive material selected from the group consisting of zirconium oxide, hafnium oxide and mixed oxides thereof.

3. The medical device according to claim 2, wherein the refractive index of the anti-corrosion layer has a refractive indexis in a range of 1.8 to 2.5.

4. The medical device according to claim 1, wherein the layer thickness of the anti-corrosion layer is in a range of 3.0 to 6.0 nm.

5. The medical device according to claim 1, wherein the anti-corrosion layer is applied by means of sputtering.

6. The medical device according to claim 5, wherein the anti-corrosion layer has a packing density of 90% or more of a theoretically maximum achievable packing density.

7. The medical device according to claim 5, wherein the anti-corrosion layer has a surface roughness Rₐ of 0.50 nm or less.

8. The medical device according to claim 1, wherein after six stripping cycles, the optical element exhibits an increase in reflectance of 1% or less, wherein one stripping cycle includes treatment of the optical element in an ultrasonic bath having a power of 300 W at a temperature of 60° C. for one hour, wherein the ultrasonic bath includes an aqueous potassium hydroxide solution having a concentration of 10 percent by weight of potassium hydroxide, based on a total weight of the potassium hydroxide solution.

9. The medical device according to claim 1, wherein the alternating layer sequence comprises one or more coats, each coat having a first sublayer and a second sublayer, and the refractive index of the first sublayer being lower than the refractive index of the second sublayer.

10. The medical device according to claim 9, wherein the anti-corrosion layer is applied directly to a first sublayer of the alternating layer sequence.

11. The medical device according to claim 9, wherein the alternating layer sequence comprises at least four coats.

12. The medical device according to claim 1, wherein the medical device is an endoscope.

13. The medical device according to claim 1, wherein the optical element is a lens or a window of the medical device.

14. An optical element having a substrate and an anti-reflective coating applied to an application surface of the substrate in a medical device,
wherein the anti-reflective coating comprises an alternating layer sequence of sublayers having different refractive indices;
wherein, in addition to the alternating layer sequence, the anti-reflective coating comprises an anti-corrosion layer, which is the layer of the anti-reflective coating that is farthest away from the application surface of the substrate;
wherein the anti-corrosion layer is designed such that a ratio of a refractive index of the anti-corrosion layer to a layer thickness of the anti-corrosion layer in nanometers is in a range of 0.3 to 0.9.

15. The optical element according to claim 14, wherein after six stripping cycles, the optical element exhibits an increase in reflectance of 1% or less, wherein one stripping cycle includes treatment of the optical element in an ultrasonic bath having a power of 300 W at a temperature of 60° C. for one hour, wherein the ultrasonic bath includes an aqueous potassium hydroxide solution having a concentration of 10 percent by weight of potassium hydroxide, based on a total weight of the potassium hydroxide solution.

16. The medical device according to claim 1, wherein the anti-corrosion layer consists of zirconium oxide.

17. The medical device according to claim 1, wherein the refractive index of the anti-corrosion layer is in a range of 1.8 to 2.5.

18. The medical device according to claim 1, wherein the refractive index of the anti-corrosion layer is in a range of 1.9 to 2.2.

19. The medical device according to claim 1, wherein the layer thickness of the anti-corrosion layer is in a range of 3.0 to 5.0 nm.

20. The medical device according to claim 1, wherein the anti-corrosion layer is applied by means of DC sputtering, RF sputtering, magnetron sputtering, or ion beam sputtering.
